(19) United States
(12) Patent Application Publication
(10) Pub. No.: US 2007/0248786 A1
(43) Pub. Date: Oct. 25, 2007

(54) WAFER HAVING AN ASYMMETRIC EDGE PROFILE AND METHOD OF MAKING THE SAME

(76) Inventor: Chih-Ping Kuo, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/456,090

(22) Filed: Jul. 7, 2006

(30) Foreign Application Priority Data
Apr. 20, 2006 (TW) 095114099

(51) Int. Cl. B32B 3/02

(52) U.S. Cl. 428/66.7

(57) ABSTRACT

A wafer having an asymmetric edge profile is provided. The wafer has a disk-like body. The disc-like body has a first main surface, a second main surface parallel to the first main surface, and an edge region. The disk-like body has a central line defined between the first main surface and the second main surface, the edge region has an edge profile, and the edge profile is asymmetric with respect to the central line of the first main surface and the second main surface.

### BACKGROUND OF THE INVENTION

1. Field of the Invention

The invention relates to a wafer having an asymmetric edge profile and a method of making the same, and more particularly, to a low stress wafer and a method of making the same.

2. Description of the Prior Art

Wafers are important bases of fabricating ultra-large scale integrated (ULSI) circuit components. With the development of crystal growth technologies, the diameters of wafers have increased from 25 millimeters in the early days of the technology to 300 millimeters (12 inches) at present. The fabricating process of the wafers includes the following main steps. First, a semiconductor liquid raw material, such as silicon, is prepared. Subsequently, a crystal pulling process is performed utilizing a seed to form a columnar ingot. Next, the ingot is cut into a plurality of disk-like wafers by slicing.

The wafers are stored in cassettes, and clipped by robots so as to transfer the wafers to each process unit. As a result, if the edge region of a wafer is perpendicular to the first main surface (front side) and the second surface (back side) of the wafer, the wafer may easily stick in the cassettes or be damaged by the robots' clipping. Furthermore, the perpendicular edge region of the wafer may easily crack due to the stress generated by temperature change in the following processes. Thus, the edge region of a wafer should be polished after the wafer is formed, so that the wafer includes an arc-shaped edge profile.

Please refer to FIG. 1. FIG. 1 is a schematic diagram of a prior art standard wafer. As shown in FIG. 1, the standard wafer 10 includes a first main surface 12, a second main surface 14, and an edge region 16. After edge polishing, the edge region 16 turns into an arc-shaped edge profile, where the edge profile is symmetric with respect to a central line of the first main surface 12 and the second main surface 14. This feature prevents the standard wafer 10 from sticking in the cassettes or being damaged by the robots' clipping, and the standard wafer 10 is thus protected.

Generally speaking, the thickness of the standard wafer 10 is changed according to the size of its diameter. For example, the thickness of the standard wafer 10 having a diameter of 8 inches is usually about 725 micrometers. With regard to the general semiconductor processes, the standard wafer 10 can prevent the aforementioned problems of cracking and damage. However, some processes, such as the micro-electromechanical system (MEMS) processes, use thinned wafers and the thicknesses of said wafers must be in the range of 50 to 250 micrometers. In consideration of these processes, the probability of damaging and cracking occurring to the standard wafer 10 is greatly increased. Please refer to FIG. 2. FIG. 2 is a schematic diagram of a thinned standard wafer. As shown in FIG. 2, the thickness of the standard wafer 10 is reduced from 725 micrometers to a thickness less than 250 micrometers (for instance, to a thickness of 200 micrometers) so as to fit the processing requirement, or other factors. In such a manner, an acute angle is formed in the edge region 16 of the standard wafer 10, the edge region 16 being in the shape of a knife. As a result, the standard wafer 10 has an increased likelihood of sticking in the cassettes. Meanwhile, the acute edge profile causes the stress of the standard wafer 10 to increase, so the probability of cracking to the standard wafer 10 is also greatly increased.

### SUMMARY OF THE INVENTION

It is therefore an objective of the present invention to provide a wafer having an asymmetric edge profile, and a method of making the same, to reduce the probability of cracking to the wafer, and to increase the yield.

According to the present invention, a wafer having an asymmetric edge profile is provided. The above-mentioned wafer includes a disk-like body, and the disk-like body includes a first main surface, a second main surface parallel to the first main surface, and an edge region. The first main surface and the second main surface define a central line between them, and the edge region has an edge profile, the edge profile being asymmetric with respect to the central line of the first main surface and the second main surface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a prior art standard wafer.

FIG. 2 is a schematic diagram of a thinned standard wafer.

FIGS. 3 to 5 are schematic diagrams of a method of fabricating a wafer having an asymmetric edge profile according to a preferred embodiment of the present invention.

FIG. 6 is a schematic diagram of the wafer, which is the same wafer in FIG. 5, but is thinned.

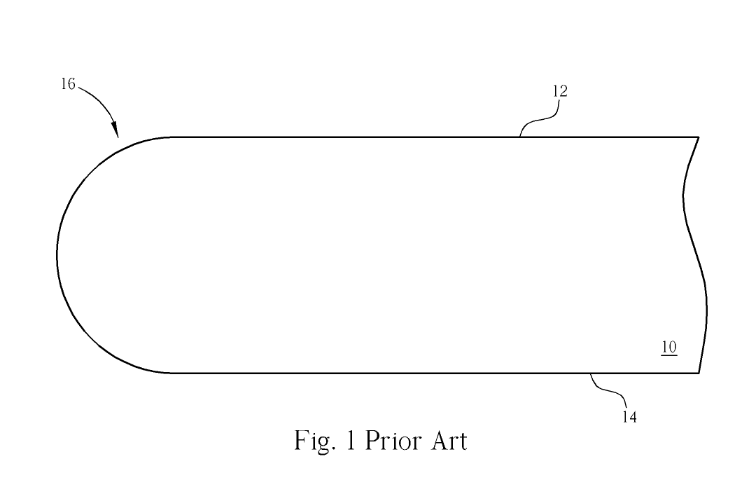

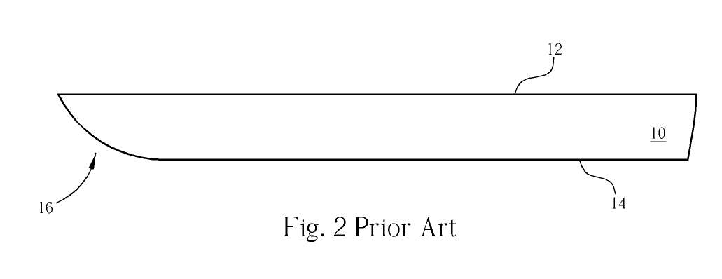

### DETAILED DESCRIPTION

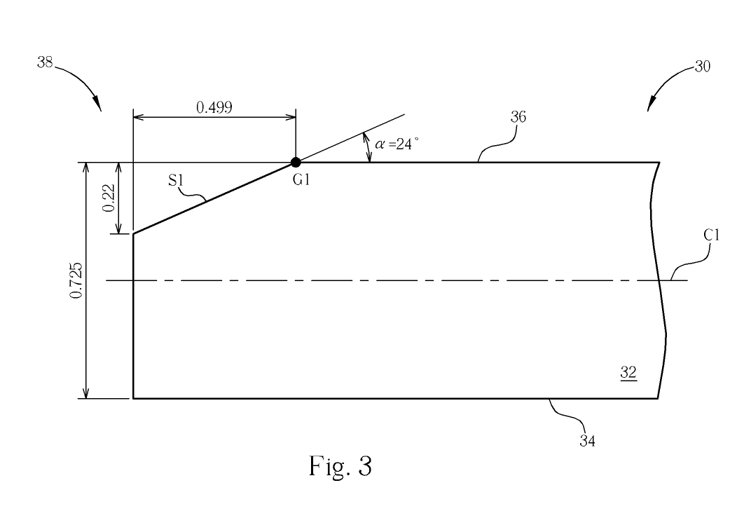

Please refer to FIGS. 3 to 5. FIGS. 3 to 5 are schematic diagrams of a method of fabricating a wafer having an asymmetric edge profile according to a preferred embodiment of the present invention. As shown in FIG. 3, a wafer 30 is first provided. The present invention takes a wafer with a diameter of 8 inches and a thickness of 725 micrometers as an example for illustrating the characteristics of the present invention, but the application is not limited to this example. The wafer 30 comprises a disk-like body 32, a first main surface 34, a second main surface 36 parallel to the first main surface 34, and an edge region 38 perpendicular to the first main surface 34 and the second main surface 36, wherein the first main surface 34 and the second main surface 36 define a central line C1 between them. Subsequently, the wafer 30 is cut along an angle α from a point G1 in the second main surface 36 of the wafer 30, so as to form a first inclined surface S1 in the edge region 38. Specifically speaking, in this preferred embodiment, the minimum distance between the point G1 and a terminal point of the second main surface 36 is 0.499 millimeters, and the angle α is 24 degrees.

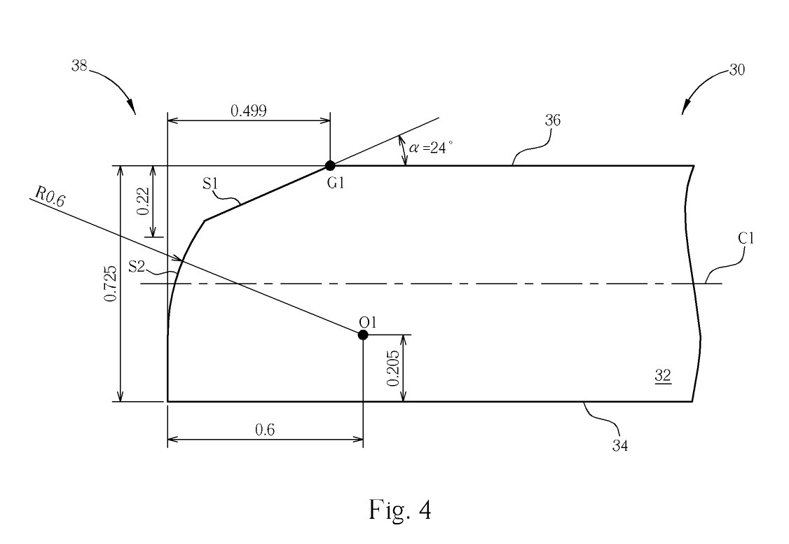

Next, as shown in FIG. 4, the edge region 38 is polished by utilizing a point O1, which does not lie in the central line C1, to be a center of curvature, and utilizing a predetermined radius R of curvature, so as to form an arc-shaped surface S2. In this preferred embodiment, the minimum distance between the point O1 and the edge region 38 is 0.6 millimeters, the minimum distance between the point O1 and the first main surface 34 is 0.205 millimeters, and the radius of curvature is 0.6 millimeters.

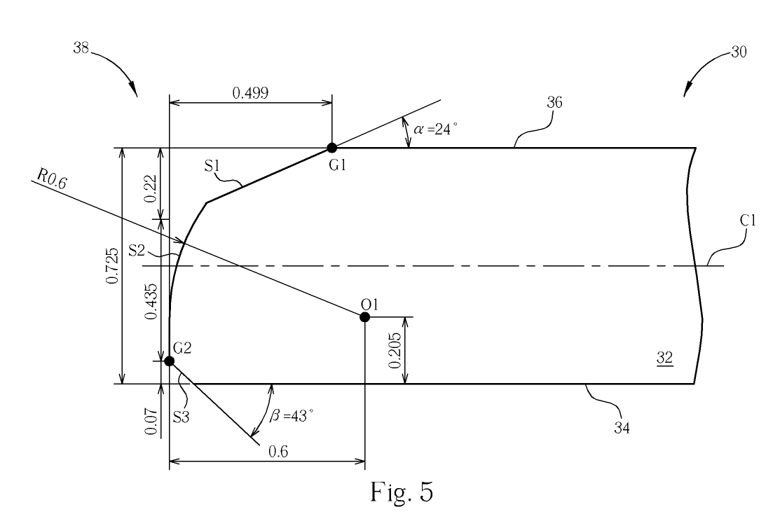

As shown in FIG. 5, the wafer 30 is thereafter cut along an angle β from a point G2 in the edge region 38 of the wafer 30, so as to form a second inclined surface S3 in the edge region 38. In this preferred embodiment, the minimum distance between the point G2 and the first main surface 34 is 0.07 millimeters, and the angle β is 43 degrees.

Hence, the wafer 30 of the present invention has an asymmetric edge profile that consists of the first inclined surface S1, the arc-shaped surface S2, and the second inclined surface S3. As a result, an included angle between a tangential line to any point on the edge profile and the first main surface 34 or the second main surface 36 is always an obtuse angle, whether the wafer 30 is at its initial thickness or the wafer 30 is thinned for the following processes. This effectively decreases the stress, and the probability of cracking to the wafer 30 occurring. It should be noted that the asymmetric edge profile consisting of the first inclined surface S1 and the arc-shaped surface S2 is merely a preferred embodiment of the present invention, and the edge profile of the wafer 30 is not limited to this embodiment. For instance, the specification of the inclined surface or of the arc-shaped surface can be adjusted by an appropriate degree, the edge profile may merely consist of a single arc-shaped surface, or the edge profile can consist of a plurality of arc-shaped surfaces. Therefore, no matter what thickness the wafer 30 is during the processes, the wafer 30 has a comparatively low stress.

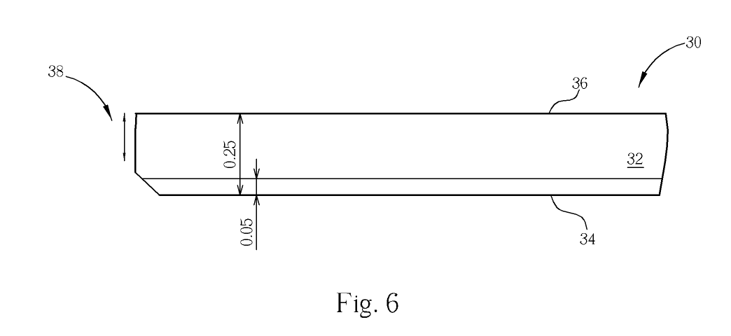

Please refer to FIG. 6. FIG. 6 is a schematic diagram of the wafer 30, which is the same wafer as in FIG. 5, but is thinned. As shown in FIG. 6, when the thickness of the wafer 30 is reduced to a range of 50 to 250 micrometers, the included angle between a tangential line to any point on the edge profile and the first main surface 34 or the second main surface 36 is still an obtuse angle. For this reason, the present invention can reduce the probability of cracking, and increase the yield.

In sum, because the wafer of the present invention has an asymmetric edge profile, the included angle between a tangential line to any point on the edge profile and the first main surface or the second main surface is always an obtuse angle, whether the wafer is at its initial thickness before any processes have been performed, or the wafer is thinned to another thickness during the processes. Thus, the present invention can effectively reduce the stress, reduce the probability of cracking, and prevent the wafer from sticking in the cassettes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wafer having an asymmetric edge profile comprising:
a disk-like body, the disk-like body comprising:
a first main surface;
a second main surface parallel to the first main surface, the first main surface and the second main surface defining a central line between them; and
an edge region, the edge region comprising an edge profile, the edge profile being asymmetric with respect to the central line of the first main surface and the second main surface.

2. The wafer of claim 1, wherein the wafer is a non-thinned wafer.

3. The wafer of claim 1, wherein the edge profile comprises an arc-shaped surface, the arc-shaped surface comprises a center of curvature and a predetermined radius of curvature, and the center of curvature does not lie in the central line.

4. The wafer of claim 3, wherein the edge profile further comprises at least an inclined surface.

5. A wafer having an asymmetric edge profile comprising:
a disk-like body with a thickness in a range of 50 to 250 micrometers, the disk-like body comprising:
a first main surface;
a second main surface parallel to the first main surface; and
an edge region, the edge region comprising an edge profile, the edge profile being asymmetric, an included angle between a tangential line to any point on the edge profile and the first main surface or the second main surface being an obtuse angle.

6. The wafer of claim 5, wherein the wafer is a non-thinned wafer.

7. A method of fabricating a wafer having an asymmetric edge profile comprising:
providing a wafer, the wafer comprising a first main surface, a second main surface parallel to the first main surface, and an edge region perpendicular to the first main surface and the second main surface, wherein the first main surface and the second main surface define a central line between them;
polishing the edge region of the wafer, so that the edge region has an edge profile asymmetric with respect to the central line of the first main surface and the second main surface;
thinning the wafer from the second main surface until the wafer reaches a predetermined thickness, an included angle between a tangential line to any point on the edge profile and the first main surface or the second main surface being an obtuse angle according to the predetermined thickness.

8. The method of claim 7, wherein the predetermined thickness is in a range of 50 to 250 micrometers.

9. The method of claim 7, wherein the step of polishing the edge region of the wafer comprises:
polishing the edge region by utilizing a predetermined radius of curvature; and
utilizing a point which does not lie in the central line to be a center of curvature, so as to form the edge profile.

10. The method of claim 9 further comprising:
polishing the edge region to make the edge profile comprise at least an inclined surface.
